(19) United States
(12) Patent Application Publication
(10) Pub. No.: US 2008/0143147 A1
(43) Pub. Date: Jun. 19, 2008

(54) Front pillar apparatus for vehicle

(75) Inventor: Jae Hyuck Lee, Seoul (KR)

Correspondence Address: EDWARDS ANGELL PALMER & DODGE LLP, P.O. BOX 55874, BOSTON, MA, 02205, US

(73) Assignee: Hyundai Motor Company, Seoul (KR)

(21) Appl. No.: 11/818,340

(22) Filed: Jun. 13, 2007

(30) Foreign Application Priority Data
Dec. 13, 2006 (KR) 10-2006-0127401

(51) Int. Cl. B62D 25/04

(52) U.S. Cl. 296/193.06

(57) ABSTRACT

A front pillar apparatus of a vehicle includes a pipe formed to be extended from an lower portion of the vehicle, a reinforcing member connected to the pipe in an outer direction of the vehicle such that the reinforcing member supports the pipe, a panel located in an inner direction of the vehicle and including one end of the panel connected to the reinforcing member, a first bracket disposed between the panel and the reinforcing member and connected to the pipe and the reinforcing member, and a bracket unit connected to a lower portion of the pipe and the panel such that the bracket supports the pipe, which apparatus has improved stiffness.

### CROSS-REFERENCE TO RELATED APPLICATION

This application claims priority to and the benefit of Korean Patent Application No. 10-2006-0127401 filed on Dec. 13, 2006, the entire contents of which are incorporated herein by reference.

### BACKGROUND OF THE INVENTION

(a) Technical Field

The present invention relates to a front pillar apparatus of a vehicle. More particularly, the present invention relates to a front pillar apparatus with improved stiffness.

(b) Background Art

A front pillar apparatus supports a windshield and a roof of a vehicle.

Typically, for example, a convertible car includes a pipe inserted in the pillar for enhancing the stiffness of the front pillar apparatus to provide protection in the event of vehicle overturn.

However, conventionally, the pipe is inserted up to an upper portion of a vehicle door, and the stiffness of the front pillar apparatus tends to be deteriorated.

In addition, where a hydroforming process in which the pipe is not inserted is used, the stiffness of the front pillar apparatus can become weak and the proportions of the apparatus produced do not fit to those of original drawings.

For these reasons, front pillar apparatuses made by hydroforming process require an additional constituent made of a plastic for fitting to the proportions of the original drawings.

Use of the additional constituent increases manufacturing costs.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a front pillar apparatus having advantages of improving stiffness and reducing manufacturing costs.

An exemplary embodiment of the present invention provides a front pillar apparatus of a vehicle including a pipe formed to be extended from a lower portion of the vehicle, a reinforcing member connected to the pipe in an outer direction of the vehicle such that the reinforcing member supports the pipe, a panel located in an inner direction of the vehicle and comprising one end of the panel connected to the reinforcing member, a first bracket disposed between the panel and the reinforcing member and connected to the pipe and the reinforcing member, and a bracket unit connected to a lower portion of the pipe and the panel such that the bracket supports the pipe.

In the embodiment, the reinforcing member can be connected to the pipe by plug welding.

Also, the first bracket can be connected to the pipe by plug welding.

Preferably, the reinforcing member may comprise an upper reinforcing member connected to an upper portion of the pipe and a lower reinforcing member connected to a lower portion of the pipe. Suitably, the connection can be made by plug welding.

Also preferably, the panel may comprise an upper panel connected to an upper portion of the pipe and a lower panel connected to a lower portion of the pipe. In this preferred embodiment, the bracket unit may comprise second, third, and fourth brackets connected to the pipe and the lower panel. At least one of the second, third, and fourth brackets can be connected to the pipe by CO2 welding. Also, at least one of the second, third, and fourth brackets can be connected to the lower panel by spot welding and a bolt.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like. The present apparatuses will be particularly useful with a wide variety of motor vehicles.

Other aspects of the invention are discussed infra.

### BRIEF DESCRIPTION OF THE DRAWINGS

FIG. 1 shows a vehicle including a front pillar apparatus according to an exemplary embodiment of the present invention.

FIG. 2 shows the ‘A’ portion of FIG. 1.

FIG. 3 shows cross-sectional views along the III-a and III-b lines of FIG. 2.

FIG. 4 shows a pipe and a bracket of a front pillar apparatus according to an exemplary embodiment of the present invention.

FIG. 5 shows cross-sectional views along the V-a and a V-b lines of FIG. 4.

Reference numerals set forth in the Drawings includes reference to the following elements as further discussed below:
100: pipe
305: first bracket
300: reinforcing member
308: panel
320: bracket unit

### DETAILED DESCRIPTION OF THE PREFERRED EMBODIMENTS

An exemplary embodiment of the present invention will hereinafter be described in detail with reference to the accompanying drawings.

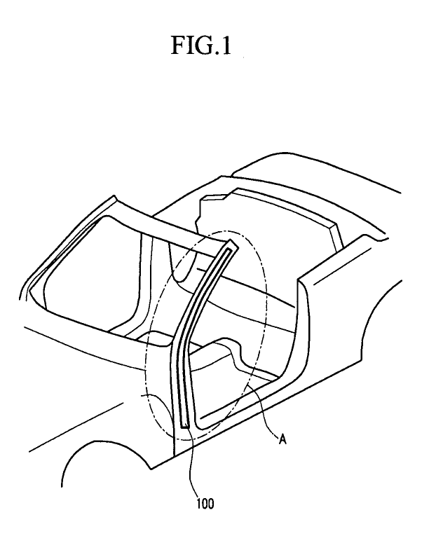

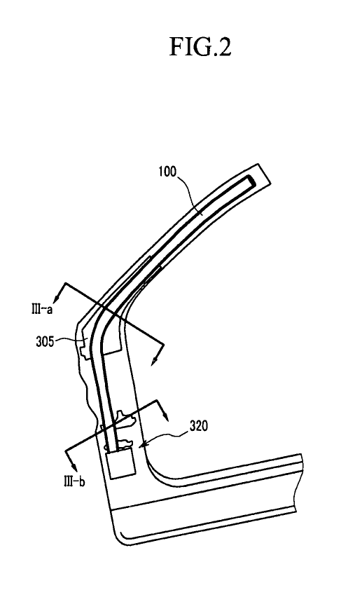

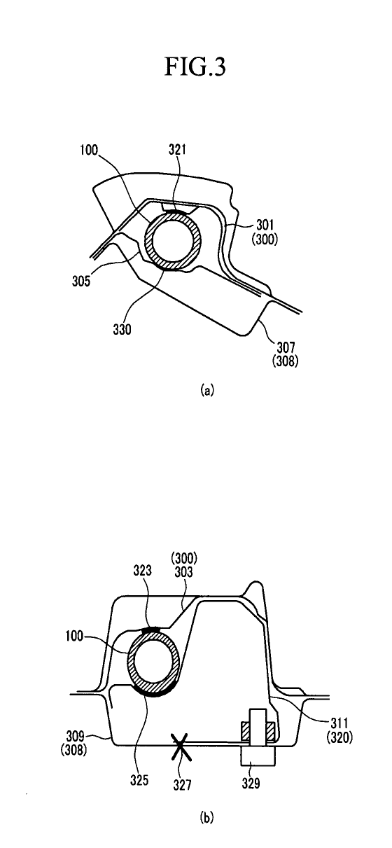

FIG. 1 shows a vehicle including a front pillar apparatus according to an exemplary embodiment of the present invention. FIG. 2 shows the ‘A’ portion of FIG. 1. FIG. 3 shows cross-sectional views along the III-a and III-b lines of FIG. 2.

As shown in FIG. 1 to FIG. 3, according to an exemplary embodiment of the present invention, a front pillar apparatus includes a pipe 100, a reinforcing member 300, a panel 308, a first bracket 305, and a bracket unit 320.

The pipe 100 is formed to be extended from a lower portion of the vehicle, and the reinforcing member 300 is connected to the pipe 100 in an outer direction of the vehicle such that the reinforcing member 300 supports the pipe 100.

The panel 308 is located in an inner direction of the vehicle and includes one end thereof connected to the reinforcing member 300, and the first bracket 305 is disposed between the panel 308 and the reinforcing member 300 and connected to the pipe 100 and the reinforcing member 300.

The bracket unit 320 is connected to a lower portion of the pipe 100 and the panel 308 such that the bracket unit 320 supports the pipe 100.

That is, as shown in FIG. 1, according to an exemplary embodiment of the present invention, the pipe 100 of the front pillar apparatus is formed to be extended from a lower portion of the vehicle to an upper portion of the front pillar apparatus

The apparatuses according to exemplary embodiments of the present invention can be applied to numerous types of vehicles including a convertible car.

Referring to FIG. 3, the first bracket 305 is disposed to a portion at which the pipe 100 is bent, and the bracket unit 320 is connected to a lower portion of the pipe 100.

Therefore, according to an exemplary embodiment of the present invention, if the vehicle overturns, safety of an occupant may be improved.

The reinforcing member 300 includes an upper reinforcing member 301 and a lower reinforcing member 303.

The upper reinforcing member 301 is connected to an upper portion of the pipe 100 and the lower reinforcing member 303 is connected to a lower portion of the pipe 100.

In addition, the reinforcing member 300 is connected to the pipe 100 by plug welding.

That is, reference numerals 321 and 323 in FIG. 3 (a) indicate plug welding portions.

Persons of ordinary skill in the art may determine the position of a connecting portion (not shown), which connects the upper reinforcing member 301 with the lower reinforcing member 303, so as to improve strength of the front pillar apparatus.

The panel 308 includes an upper panel 307 connected to the upper portion of the pipe 100 and a lower panel 309 connected to the lower portion of the pipe 100.

Also, persons of ordinary skill in the art may determine the position of a connecting portion (not shown), which connects the upper panel 307 with the lower panel 309, so as to improve strength of the front pillar apparatus.

The first bracket 305 may be connected to the pipe 100 by plug welding.

That is, reference numeral 330 in FIG. 3 indicates a portion formed by plug welding between the first bracket 305 and the pipe 100.

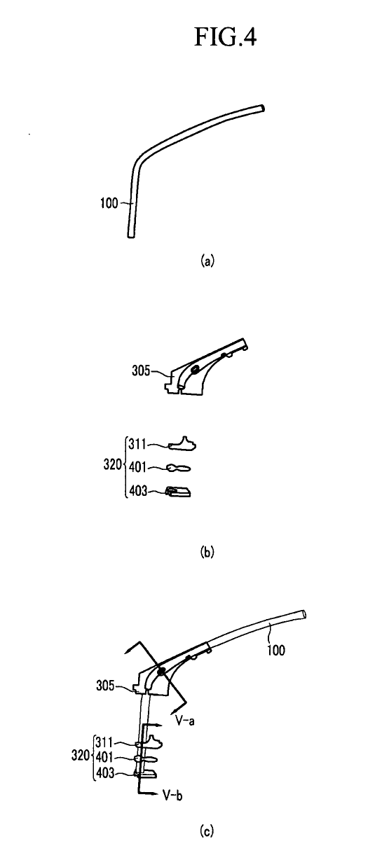

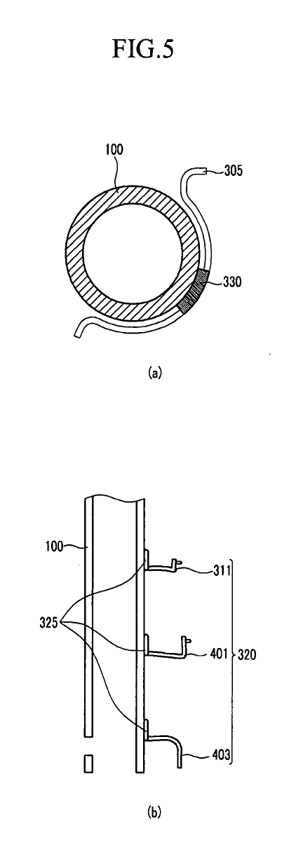

FIG. 4 shows a pipe and a bracket of a front pillar apparatus according to an exemplary embodiment of the present invention. FIG. 5 shows cross-sectional views along the V-a and a V-b lines of FIG. 4.

As shown in FIG. 4 and FIG. 5, the bracket unit 320 may include second, third, and fourth brackets 311, 401, and 403 connected to the pipe 100 and the lower panel 309.

At least one of the second, third, and fourth brackets 311, 401, and 403 may be connected to the pipe 100 by CO₂ welding, and be connected to the lower panel 309 by spot welding and a bolt.

That is, referring FIG. 3(b) and FIG. 5(b), reference numeral 325 indicates CO₂ welding portion at which the bracket unit 320 and the pipe 100 are connected.

In addition, referring to FIG. 3(b), reference numerals 327 and 329 indicate the spot welding portion and the bolt with which the lower panel 309 and the bracket unit 320 are connected.

With these structures, the second, third, and fourth brackets 311, 401, and 403 can be more strongly connected to the panel 308 and the pipe 100.

As shown above, the present apparatuses according to exemplary embodiments includes a plurality of brackets disposed, which can improve the strength of the front pillar apparatus and vehicle occupants' safety.

In addition, because an additional constituent for fitting the proportions is not necessary, the manufacturing costs can be reduced.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A front pillar apparatus of a vehicle, comprising:
a pipe formed to be extended from a lower portion of the vehicle;
a reinforcing member connected to the pipe in an outer direction of the vehicle such that the reinforcing member supports the pipe;
a panel located in an inner direction of the vehicle and comprising one end of the panel connected to the reinforcing member;
a first bracket disposed between the panel and the reinforcing member and connected to the pipe and the reinforcing member; and
a bracket unit connected to a lower portion of the pipe and the panel such that the bracket unit supports the pipe.

2. The apparatus of claim 1, wherein the reinforcing member is connected to the pipe by plug welding.

3. The apparatus of claim 1, wherein the first bracket is connected to the pipe by plug welding.

4. The apparatus of claim 1, wherein the reinforcing member comprises:
an upper reinforcing member connected to an upper portion of the pipe; and
a lower reinforcing member connected to a lower portion of the pipe.

5. The apparatus of claim 4, wherein the connection is made by plug welding.

6. The apparatus of claim 1, wherein the panel comprises:
an upper panel connected to an upper portion of the pipe; and
a lower panel connected to a lower portion of the pipe.

7. The apparatus of claim 6, wherein the bracket unit comprises second, third, and fourth brackets connected to the pipe and the lower panel.

8. The apparatus of claim 7, wherein at least one of the second, third, and fourth brackets is connected to the pipe by CO₂ welding.

9. The apparatus of claim 8, wherein at least one of the second, third, and fourth brackets is connected to the lower panel by spot welding and a bolt.
